(19) United States
(12) Patent Application Publication
(10) Pub. No.: US 2026/0051583 A1
(43) Pub. Date: Feb. 19, 2026

(54) APPARATUS FOR MANUFACTURING SECONDARY BATTERY

(71) Applicant: Samsung SDI Co., Ltd., Yongin-si (KR)

(72) Inventors: Joung Ku Kim, Suwon-si (KR); Ki Jun Kim, Suwon-si (KR); Jung Hwan Lee, Suwon-si (KR); Min Sun Lee, Suwon-si (KR); Young Ho Kim, Suwon-si (KR); Seon Ran Choi, Suwon-si (KR)

(73) Assignee: Samsung SDI Co., Ltd., Yongin-si (KR)

(21) Appl. No.: 19/234,961

(22) Filed: Jun. 11, 2025

(30) Foreign Application Priority Data
Aug. 13, 2024 (KR) 10-2024-0108452

(51) Int. Cl. H01M 50/167; B21D 39/04; H01M 10/04; H01M 50/107

(52) U.S. Cl. CPC H01M 50/167; B21D 39/048; H01M 10/0422; H01M 50/107

(57) ABSTRACT

The present disclosure relates to an apparatus for manufacturing a secondary battery and is directed to providing an apparatus for manufacturing a secondary battery in which a crimping part is formed by bending an end part of a battery can and which has a simple structure and improved operational reliability. To this end, the present disclosure provides an apparatus for manufacturing a secondary battery, which includes: a jig part that moves from an outside of a battery can toward the battery can and presses the battery can to bend inwardly; and a jig pressing part that presses the jig part so that the jig part presses the battery can by moving in a direction intersecting a movement direction of the jig part.

### CROSS-REFERENCE TO RELATED APPLICATIONS

This present application claims priority to and the benefit under 35 U.S. C. § 119(a)-(d) of Korean Patent Application No. 10-2024-0108452, filed on Aug. 13, 2024, in the Korean Intellectual Property Office, the entire disclosure of which is incorporated herein by reference.

### FIELD

The present disclosure relates to an apparatus for manufacturing a secondary battery.

### BACKGROUND

In general, with the recent proliferation of electronic devices using batteries, such as mobile phones, notebook computers, and electric vehicles, the demand for secondary batteries having high energy density and high capacity has rapidly increased. Accordingly, research and development to improve the performance of lithium secondary batteries are being actively conducted.

The secondary battery may include a case and an electrode assembly accommodated in the case. In the circumstance of a cylindrical secondary battery, a case may include a battery can and a cap assembly coupled to the battery can by crimping.

The aforementioned information disclosed in this background section is merely for enhancement of understanding of the background technology of the present disclosure, and therefore may contain information that does not constitute the related art.

### SUMMARY

The present disclosure is directed to providing an apparatus for manufacturing a secondary battery in which a crimping part is formed by bending an end part of a battery can and which has a simple structure and improved operational reliability.

However, technical objectives to be achieved by the present disclosure are not limited to the above-described objectives, and other objectives, which are not described above, will be clearly understood by those skilled in the art through the following description of the disclosure.

According to an aspect of the present disclosure, there is provided an apparatus for manufacturing a secondary battery, which includes: a jig part that moves from an outside of a battery can toward the battery can and presses the battery can to bend inwardly; and a jig pressing part that presses the jig part so that the jig part presses the battery can by moving in a direction intersecting a movement direction of the jig part.

The jig part may move in a direction toward the battery can and in a direction away from the battery can and include a plurality of slide jigs for pressing the battery can.

The plurality of slide jigs may move in a radial direction away from a central axis of the battery can and in a direction opposite to the radial direction.

At least one slide jig may include an end portion contact surface that moves toward the battery can and comes into contact with one side end portion of the battery can, a round pressing surface that is connected to the end portion contact surface and presses the one side end portion so that the one side end portion is bent toward a central axis of the battery can, and an inwardly protruding surface connected to the round pressing surface and protruding toward the central axis.

The battery can may further include a side wall spaced apart from the one side end portion, and a beading part interposed between the one side end portion and the side wall and concavely recessed toward the central axis, and the at least one slide jig further may further include a side wall contact surface that comes into contact with the side wall, and a beading part insertion protrusion positioned between the end portion contact surface and the side wall contact surface and protruding toward the central axis to be inserted into the beading part.

A shortest distance between the central axis and the beading part insertion protrusion may be longer than a shortest distance between the central axis and the inwardly protruding surface.

The apparatus for manufacturing a secondary battery may further include a frame part movably supporting the slide jig.

The frame part may include a hollow portion through which the battery can passes.

The frame part may include a slide groove into which the slide jig is movably fitted.

Any one of the frame part and the slide jig may include a guide rail protruding toward the other and extending in a direction parallel to the movement direction of the slide jig, and the other may include a long guide groove that is recessed inwardly so that the guide rail is fitted thereinto and extending parallel to a longitudinal direction of the guide rail.

The jig pressing part may approach the at least one slide jig in a direction perpendicular to the movement direction of the at least one slide jig and press the at least one slide jig so that the at least one slide jig comes into close contact with the battery can.

The at least one slide jig may include an outer peripheral inclined surface opposite to the battery can and inclined with respect to the central axis CX, and the jig pressing part may include a pusher for pressing the outer peripheral inclined surface to bring the at least one slide jig into contact with the battery can.

The jig pressing part may further include an inner peripheral inclined surface facing the outer peripheral inclined surface.

The jig pressing part may include an inner side surface parallel to the movement direction of the jig pressing part between the inner peripheral inclined surface and the pusher, and the at least one slide jig may include an outer side surface in close contact with the inner side surface.

Any one of the jig pressing part and the at least one slide jig may include a rotation preventing protrusion protruding toward the other and extending parallel to the movement direction of the jig pressing part, and the other may include a rotation prevention groove which is recessed inwardly so that the rotation preventing protrusion is fitted thereinto and extending parallel to a longitudinal direction of the rotation preventing protrusion.

When the plurality of slide jigs press the battery can, the plurality of slide jigs may surround the battery can and may be in close contact with each other.

The plurality of slide jigs may be elastically biased in the direction away from the battery can.

The apparatus for manufacturing a secondary battery may further include a frame part which movably supports at least one slide jig and a hollow through which the battery can passes, and the at least one slide jig may include: a block part including an end portion contact surface which moves toward the battery can and comes into contact with one side end portion of the battery can, a round pressing surface which is connected to the end portion contact surface and presses the one side end portion so that the one side end portion is bent toward a central axis of the battery can, and an inwardly protruding surface which is connected to the round pressing surface and protrudes toward the central axis; and a plate part which is connected to the block part and movably supported on the frame part.

The block part may include an outer peripheral inclined surface opposite to the battery can and inclined with respect to the central axis of the battery can, and an outer side surface which is positioned between the outer peripheral inclined surface and the plate part and parallel to the movement direction of the jig pressing part, and the jig pressing part may include a pusher for pressing the outer peripheral inclined surface to bring the block part into contact with the battery can, an inner peripheral inclined surface facing the outer peripheral inclined surface, and an inner side surface which is positioned between the outer peripheral inclined surface and in close contact with the outer side surface.

When the block part presses the battery can, the block part may be positioned on an inner side of the jig pressing part and the plate part may be positioned on an outer side of the jig pressing part.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a perspective view of an apparatus for manufacturing a secondary battery according to at least one embodiment of the present disclosure and is a diagram illustrating a state in which jigs are spaced apart from each other;

FIG. 2 is a perspective view of the apparatus for manufacturing a secondary battery according to at least one embodiment of FIG. 1 and is a diagram illustrating a state in which the jigs of FIG. 1 are in close contact with one another;

FIG. 3 is a top perspective view illustrating the apparatus for manufacturing a secondary battery of FIG. 1;

FIG. 4 is a bottom perspective view illustrating the apparatus for manufacturing a secondary battery of FIG. 1;

FIG. 5 is an enlarged view illustrating portion A of FIG. 3;

FIG. 6 is an enlarged view illustrating portion B of FIG. 4;

FIG. 7 is a perspective view illustrating a secondary battery manufactured by the apparatus for manufacturing a secondary battery of the present disclosure;

FIG. 8 is a longitudinal cross-sectional view of the secondary battery of FIG. 7;

FIG. 9 is a plan view of the apparatus for manufacturing a secondary battery of FIGS. 1 and 2 and is a diagram illustrating a state in which the secondary battery is pressed;

FIG. 10 is a longitudinal cross-sectional view illustrating a state just before the secondary battery is processed by the apparatus for manufacturing a secondary battery of FIGS. 1 and 2 and is a diagram corresponding to the diagram of FIG. 9 along a line C-C;

FIG. 11 is a longitudinal cross-sectional view illustrating a state just before the secondary battery is processed by the apparatus for manufacturing a secondary battery of FIGS. 1 and 2 and is a diagram corresponding to the diagram of FIG. 9 along a line C-C; and

FIG. 12 is an enlarged view illustrating portion D of FIG. 11.

### DETAILED DESCRIPTION

Herein, some embodiments of the present disclosure will be described, in further detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term.

The embodiments described in this specification and the configurations shown in the drawings are provided as some example embodiments of the present disclosure and do not represent all of the technical ideas, aspects, and features of the present disclosure. Accordingly, it is to be understood that there may be various equivalents and modifications that may replace or modify the embodiments described herein at the time of filing this application.

It is to be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same or like elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B, and C,” “at least one of A, B, or C,” “at least one selected from a group of A, B, and C,” or “at least one selected from among A, B, and C” are used to designate a list of elements A, B, and C, the phrase may refer to any and all suitable combinations or a subset of A, B, and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It is to be understood that, although the terms “first,” “second,” “third,” etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It is to be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (e.g., rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It is to be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

References to two compared elements, features, etc. as being “the same” may mean that they are “substantially the same.” Thus, the phrase “substantially the same” may include a circumstance having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

When an arbitrary element is referred to as being arranged (or located or positioned) on the “above (or below)” or “on (or under)” a component, it may mean that the arbitrary element is placed in contact with the upper (or lower) surface of the component and may also mean that another component may be interposed between the component and any arbitrary element arranged (or located or positioned) on (or under) the component.

In addition, it is to be understood that when an element is referred to as being “coupled,” “linked,” or “connected” to another element, the elements may be directly “coupled,” “linked,” or “connected” to each other, or one or more intervening elements may be present therebetween, through which the element may be “coupled,” “linked,” or “connected” to another element. In addition, when a part is referred to as being “electrically coupled” to another part, the part may be directly electrically connected to another part or one or more intervening parts may be present therebetween such that the part and the another part are indirectly electrically connected to each other.

Throughout the specification, when “A and/or B” is stated, it means A, B, or A and B, unless otherwise stated. That is, “and/or” includes any or all combinations of a plurality of items enumerated. When “C to D” is stated, it means C or more and D or less, unless otherwise specified.

The terms used in the present specification are for describing embodiments of the present disclosure and are not intended to limit the present disclosure.

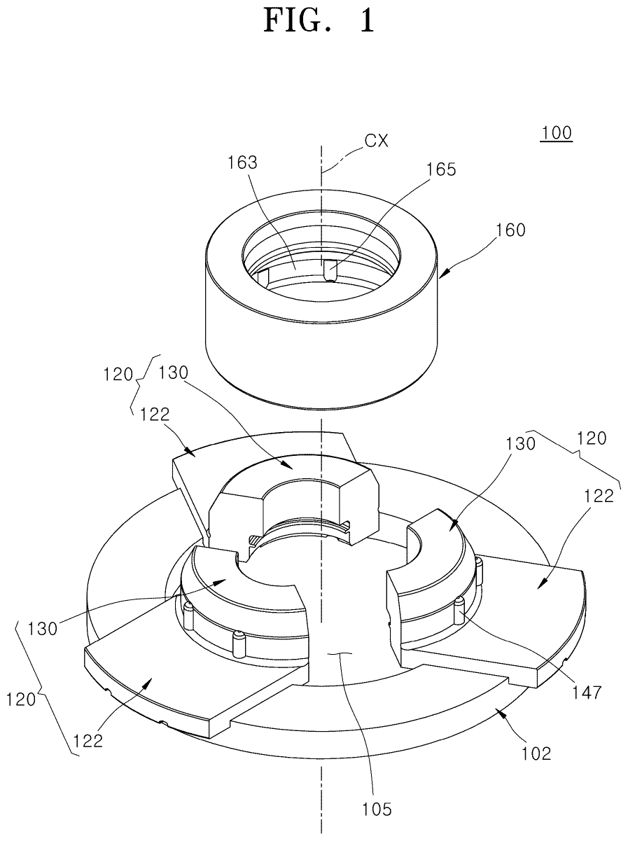

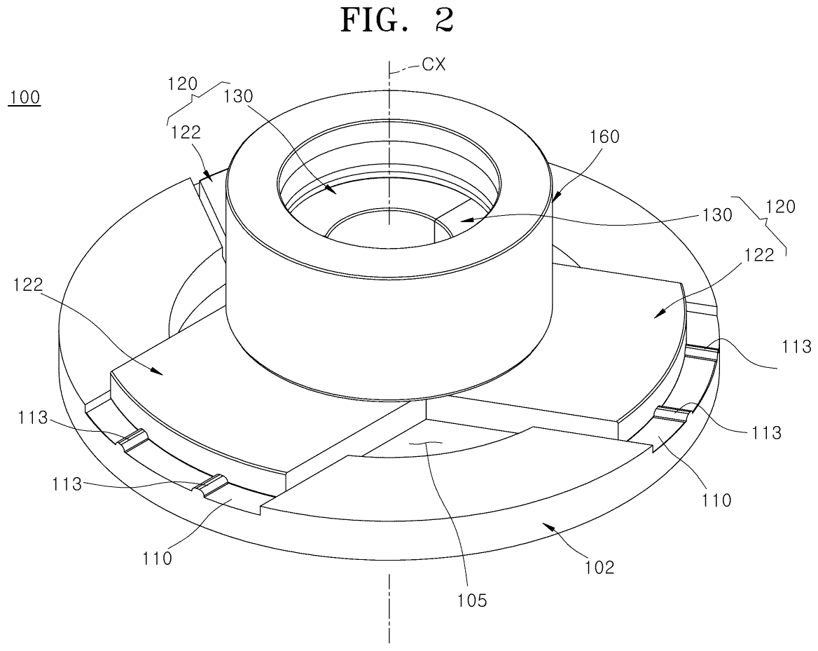

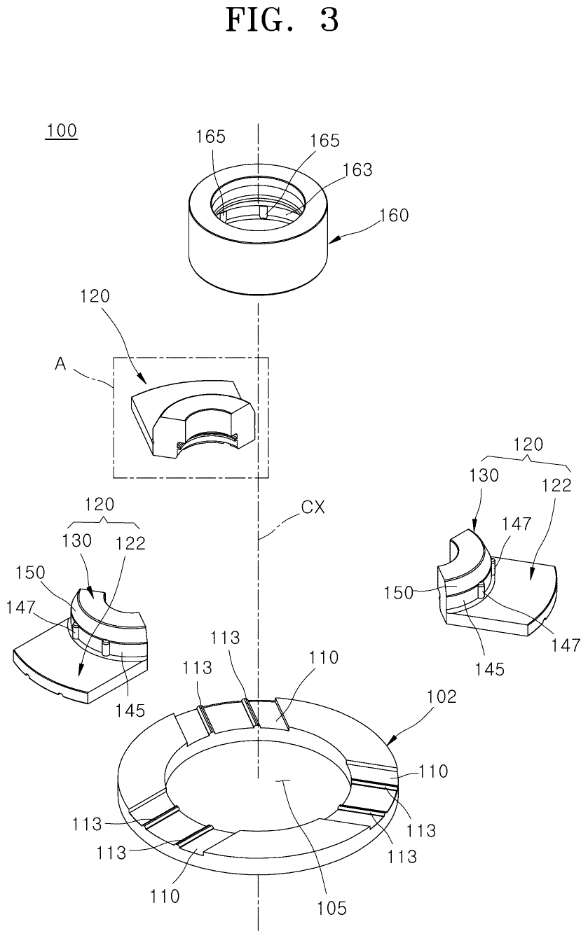

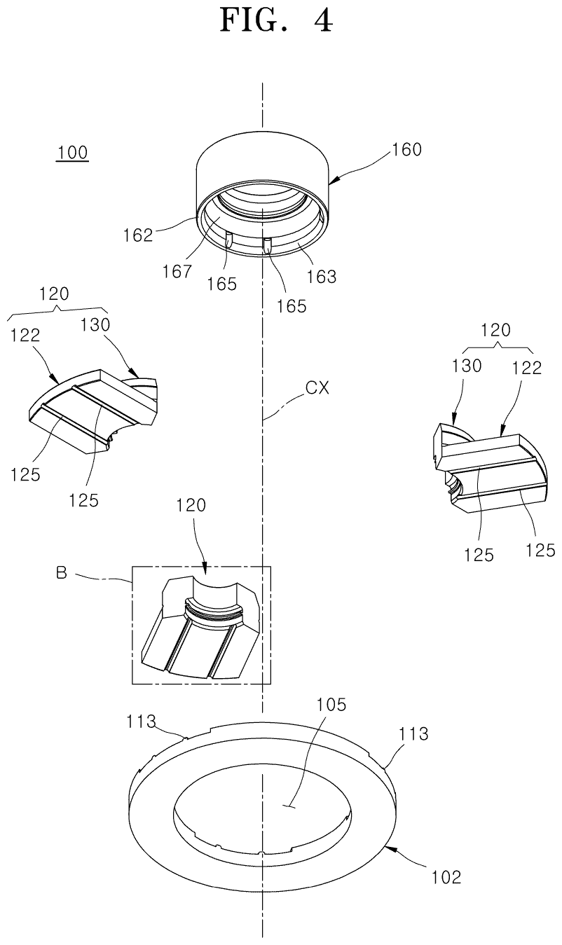

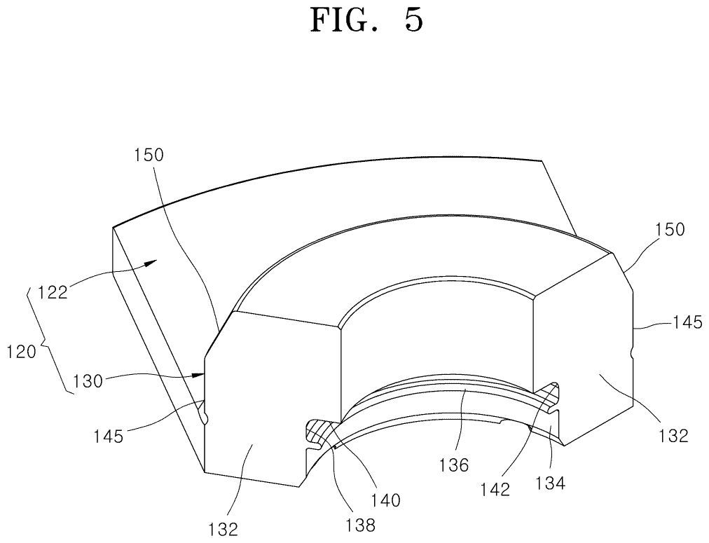

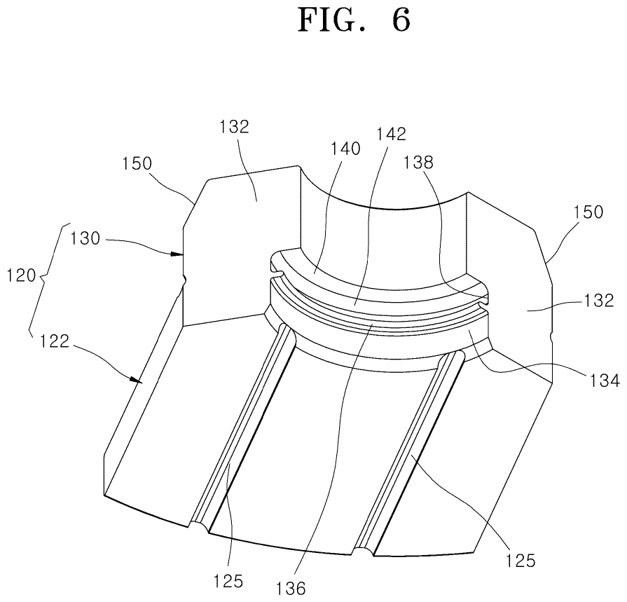

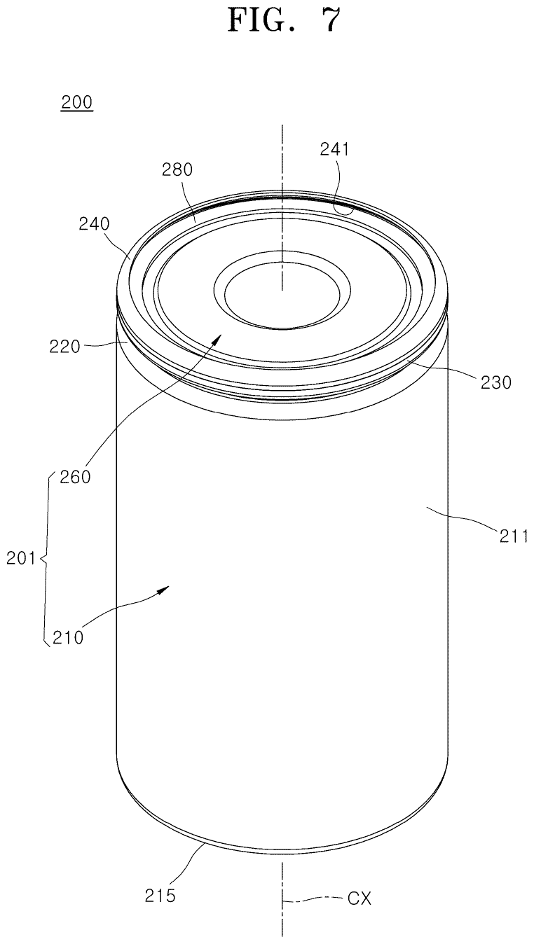

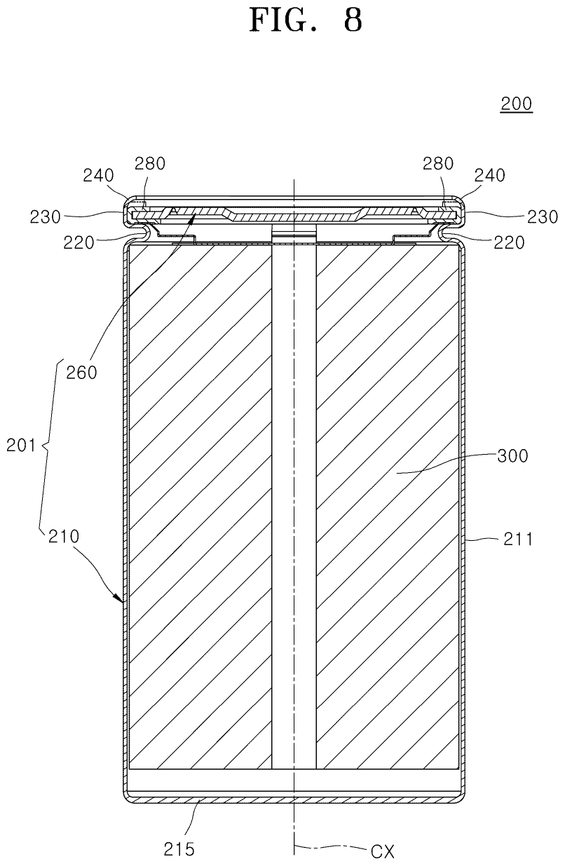

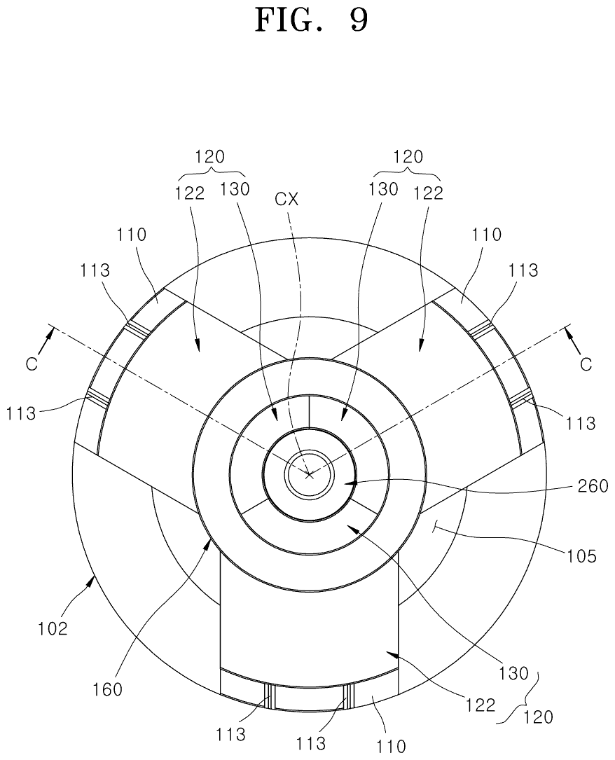

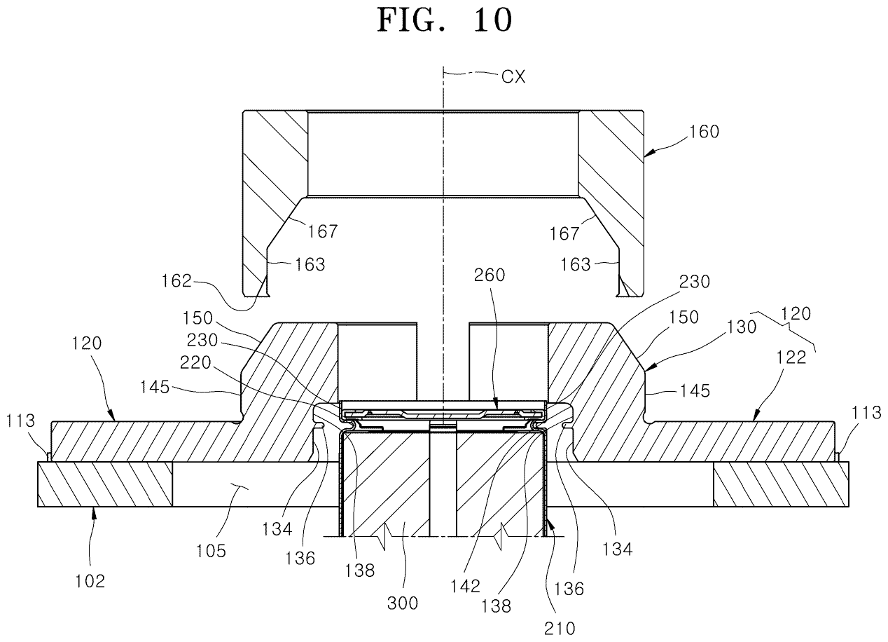

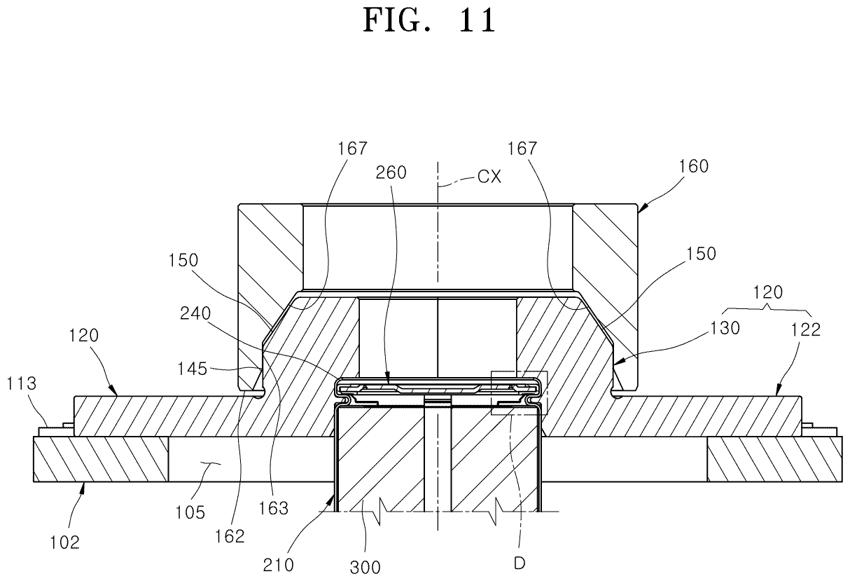

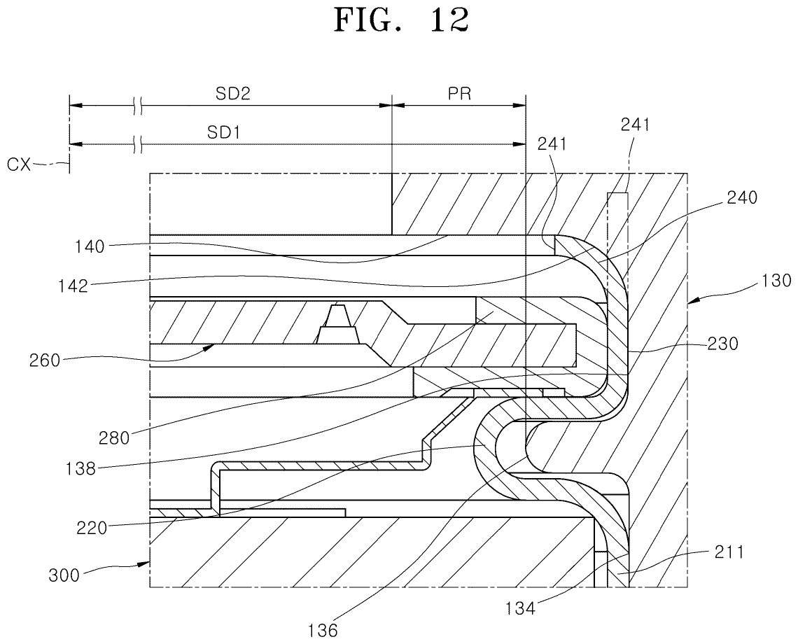

FIG. 1 is a perspective view of an apparatus for manufacturing a secondary battery according to at least one embodiment of the present disclosure and is a diagram illustrating a state in which jigs are spaced apart from each other. FIG. 2 is a perspective view of the apparatus for manufacturing a secondary battery according to at least one embodiment of FIG. 1 and is a diagram illustrating a state in which the jigs of FIG. 1 are in close contact with one another. FIG. 3 is a top perspective view illustrating the apparatus for manufacturing a secondary battery of FIG. 1. FIG. 4 is a bottom perspective view illustrating the apparatus for manufacturing a secondary battery of FIG. 1. FIG. 5 is an enlarged view illustrating portion of FIG. 3. FIG. 6 is an enlarged view illustrating portion B of FIG. 4. FIG. 7 is a perspective view illustrating a secondary battery manufactured by the apparatus for manufacturing a secondary battery of the present disclosure. FIG. 8 is a longitudinal cross-sectional view of the secondary battery of FIG. 7. FIG. 9 is a plan view of the apparatus for manufacturing a secondary battery of FIGS. 1 and 2 and is a diagram illustrating a state in which the secondary battery is pressed. FIG. 10 is a longitudinal cross-sectional view illustrating a state just before the secondary battery is processed by the apparatus for manufacturing a secondary battery of FIGS. 1 and 2 and is a diagram corresponding to the diagram of FIG. 9 along a line C-C. FIG. 11 is a longitudinal cross-sectional view illustrating a state just before the secondary battery is processed by the apparatus for manufacturing a secondary battery of FIGS. 1 and 2 and is a diagram corresponding to the diagram of FIG. 9 along a line C-C. FIG. 12 is an enlarged view illustrating portion D of FIG. 11.

Referring to FIGS. 1 to 9, the apparatus for manufacturing a secondary battery 100 according to at least one embodiment of the present disclosure includes a jig part and a jig pressing part 160. The jig part moves from the outside of a battery can 210 toward the battery can 210 to press the battery can 210 to be bent inwardly.

The jig part may include a plurality of slide jigs 120. The plurality of slide jigs 120 may each move toward the battery can 210 and move away from the battery can 210. The slide jig 120 may move toward the battery can 210 and press the battery can 210.

The battery can 210 may be, for example, the battery can 210 for a cylindrical secondary battery 200. Referring to FIGS. 7 and 8, the cylindrical secondary battery 200 may include a case 201 and an electrode assembly 300.

The case 201 may form the exterior of the secondary battery 200. The case 201 may include the battery can 210 and a cap plate 260. The battery can 210 may be electrically conductive. For example, the battery can 210 may include at least one or more of steel, stainless steel, aluminum, and an aluminum alloy. Accordingly, the battery can 210 may protect the electrode assembly 300 from external impacts and perform a heat dissipation function to radiate heat generated during the charging/discharging operation of the electrode assembly 300 to the outside.

The battery can 210 may have a cylindrical shape extending along a central axis CX. The battery can 210 may include a side wall 211 and a bottom 215 which form a tubular shape. The bottom 215 is formed to have a roughly disk shape and may be disposed to face a lower end portion of side wall 211. A circumferential surface of the bottom 215 may be coupled to a lower end portion of the side wall 211.

The bottom 215, for example, may be integrally formed with the side wall 211 by a drawing process or may be manufactured separately from the side wall 211 and then coupled to the side wall 211 by welding or the like.

One side in a longitudinal direction of the battery can 210, for example, an upper side based on FIGS. 7 and 8 may be open. The other side in the longitudinal direction of the battery can 210 may be closed by the bottom 215.

The electrode assembly 300 may be inserted into the battery can 210 through the one open side of the battery can 210. After the electrode assembly 300 is inserted into the battery can 210, the cap plate 260 may be inserted into the battery can 210 through the one open side of the battery can 210 to cover the electrode assembly 300.

The electrode assembly 300 may function as a unit structure that performs charging and discharging operations of power in the secondary battery 200. The electrode assembly 300 may include a first electrode plate, a second electrode plate, and a separator disposed between the first electrode plate and the second electrode plate. The electrode assembly 300 may have a wound shape centered on a winding axis.

The first electrode plate may function as a positive electrode of the electrode assembly 300. The second electrode plate may function as a negative electrode of the electrode assembly 300. The separator may be disposed between the first electrode plate and the second electrode plate. The separator may perform a function of preventing a short circuit between the first electrode plate and the second electrode plate while allowing lithium ions to move between the first electrode plate and the second electrode plate.

The cap plate 260 may be coupled to the battery can 210 to cover the electrode assembly 300 so that the electrode assembly is not exposed and closes the one side of the battery can 210. The battery can 210 may further include a beading part 220 interposed between a one open side end portion 230 and the side wall 211 and concavely recessed toward the central axis CX.

The beading part 220 may protrude into an inner space of the battery can 210 and may be interposed between the electrode assembly 300 and the cap plate 260. The beading part 220 may restrict the cap plate 260 from being excessively inserted toward the bottom 215 inside the battery can 210.

The battery can 210 may further include a crimping part 240 formed by bending an end portion including an end corner 241 of the one side end portion 230 toward the central axis CX. The crimping part 240 may block an outer circumferential portion of the cap plate 260 to prevent the cap plate 260 from being separated to the outside of the battery can 210.

The secondary battery 200 may further include a gasket 280 interposed between the battery can 210 and the outer circumferential portion of the cap plate 260. The gasket 280 may electrically insulate the battery can 210 and the cap plate 260 from each other and may prevent moisture or an electrolyte from flowing in or out between the battery can 210 and the cap plate 260.

The gasket 280 may be an annular member. An inner side surface of the gasket 280 may be in close contact with the outer circumferential portion of the cap plate 260, an outer surface of the gasket 280 may be in close contact with the beading part 220, the one side end portion 230, the crimping part 240 of the battery can 210.

In FIGS. 7 and 8, it is illustrated that the crimping part 240 is not in close contact with the gasket 280. The battery can 210 of the secondary battery 200 illustrated in FIGS. 7 and 8 includes the crimping part 240 formed by being pressed by the apparatus for manufacturing a secondary battery 100 according to an embodiment of the present disclosure.

The apparatus for manufacturing a secondary battery 100 according to at least one embodiment of the present disclosure includes an apparatus that may perform processing to form the crimping part 240 by primarily bending an end portion of the one side end portion 230 parallel to the central axis CX to approach the cap plate 260 or the gasket 280, like the side wall 211.

To elaborate, the secondary battery 200 illustrated in FIGS. 7 and 8 is a semi-finished secondary battery product, and a finished secondary battery product in which the cap plate 260 is fixed to the battery can 210 so as not to be separated from the battery can 210 through additional processing which presses the crimping part 240 spaced apart from the cap plate 260 or the gasket 280 to come into close contact with the cap plate 260 or the gasket 280.

Referring again to FIGS. 1 to 9, the apparatus for manufacturing a secondary battery 100 may further include a frame part 102 that movably supports the plurality of slide jigs 120. The frame part 102 may be an annular member. The frame part 102 may include a hollow 105 through which the battery can 210 passes.

The hollow 105 may be formed to pass through the frame part 102 in a thickness direction of the frame part 102. A center line of the hollow 105 may coincide with the central axis CX of the battery can 210.

The plurality of slide jigs 120 may move in a radial direction away from the central axis CS of the battery can 210 and in a direction opposite to the radial direction while supported by the frame part 102. Since the direction opposite to the radial direction is a direction toward the central axis CX, the direction is referred to as an axial direction below.

The frame part 102 may include a plurality of slide grooves 110 into which the plurality of slide jigs 120 are fitted so as to movable in the radial direction and the axial direction. The frame part 102 may include a guide rail 113 which extends parallel to the movement direction of the slide jig 120, that is, the radial direction and the axial direction. The guide rail 113 may protrude from a bottom surface of the slide groove 110 toward the slide jig 120.

The slide jig 120 may include a long guide groove 125 that is recessed inwardly so that the guide rail 113 is fitted thereinto and extending parallel to a longitudinal direction of the guide rail 113. Meanwhile, unlike the embodiments illustrated in FIGS. 3 to 6, the slide jig may include the guide rail, and the frame part may include the long guide groove into which the guide rail is fitted.

The slide jig 120 may include a plate part 122 and a block part 130. The plate part 122 is a plate-shaped part that may be supported on the frame part 102 and may slide and move. The long guide groove 125 may be provided in the plate part 122.

The block part 130 and the plate part 122 may be connected to each other. The block part 130 may be positioned closer to the battery can 210 than the plate part 122. The block part 130 may include a side wall contact surface 134, an end portion contact surface 138, a round pressing surface 142, an inwardly protruding surface 140, and a beading part insertion protrusion 136.

The side wall contact surface 134 is in contact with the side wall 211 of the battery can 210 The end portion contact surface 138 is in contact with the one side end portion 230 of the battery can 210 The round pressing surface 142 is connected to the end portion contact surface 138. The round pressing surface 142 may be a concave curved surface.

The round pressing surface 142 presses the one side end portion 230 so that the one side end portion 230 of the battery can 210 is bent toward the central axis CX of the battery can 210. The inwardly protruding surface 140 is connected to the round pressing surface 142. The inwardly protruding surface 140 may protrude toward the central axis CX. The inwardly protruding surface 140 may be a surface which is perpendicular to the central axis CX.

The beading part insertion protrusion 136 may be positioned between the end portion contact surface 138 and the side wall contact surface 134. The beading part insertion protrusion 136 may protrude toward the central axis CX to be inserted into a concave groove formed in the outer side of the beading part 220. The beading part insertion protrusion 136 may protrude, for example, in an annular shape.

When the slide jig 120 moves toward the battery can 210 and the beading part insertion protrusion 136 is fitted into the beading part, the battery can 210 may be fixed without fluctuating in the direction of the central axis CX, that is, in the longitudinal direction of the battery can 210. Accordingly, a defect in the work of forming the crimping part 240 may be suppressed.

Referring to FIG. 12, an inner side end portion of the inwardly protruding surface 140 may further protrude toward the central axis CX by a predetermined distance PR in the radial direction of the central axis CS than an inner side end portion of the beading part insertion protrusion 136. Additionally, a shortest distance SD1 between the central axis CX and the beading part insertion protrusion 136 may be longer than a shortest distance SD2 between the central axis CX and the inwardly protruding surface 140.

When the shortest distance SD1 is shorter than or equal to the shortest distance SD2, even when the block part 130 of the slide jig 120 is in close contact with the battery can 210, the end corner 241 of the one side end portion 230 may not be sufficiently bent toward the central axis CX. In this circumstance, the crimping part 240 may be damaged or broken during an additional processing operation of pressing the crimping part 240 to come into close contact with the cap plate 260 or the gasket 280, and a press mold or tool may be damaged.

Referring to FIGS. 1 to 12, the jig pressing part 160 moves in a direction intersecting a movement direction of the jig part and presses the jig part so that the jig part presses the battery can 210. The jig pressing part 160 may approach the plurality of side jigs 120 in a direction perpendicular to a movement direction of the plurality of slide jigs 120 and press the plurality of slide jigs 120 so that the plurality of slide jigs 120 come into close contact with the battery can 210.

For example, the plurality of slide jigs 120 may move in the radial direction and the axial direction based on the central axis CX of the battery can 210, and the jig pressing part 160 may move in a direction approaching the battery can 210 and a direction away from the battery can 210 along the central axis CX.

The plurality of slide jigs 120 may simultaneously move toward the central axis CX by the jig pressing part 160. When the plurality of slide jigs 120 come into close contact with the battery can 210 to press the battery can 210, the plurality of slide jigs 120 may surround the battery can 210 and come into close contact with each other. Additionally, a block part side surface 132 provided in one block part 130 may come into close with the block part side surface 132 provided to face another neighboring block part 130.

For example, the number of slide jigs 120 may be three. The three slide jigs 120 may be disposed at equal angular intervals around the central axis CX.

The jig pressing part 160 may include an annular member in which a hollow is formed in the direction of the central axis. The block part 130 of each slide jig 120 may include an outer peripheral inclined surface 150 opposite to the battery can 210 and inclined with respect to the central axis CX.

The jig pressing part 160 may include a pusher 162 pressing the outer peripheral inclined surface 150 so that the slide jig 120 comes into contact with the battery can 210. The pusher 162 may be an annular end of the jig pressing part 160 facing the plurality of slide jigs 120.

When the jig pressing part 160 is spaced apart from the plurality of slide jigs 120, the outer peripheral inclined surface 150 and the pusher 162 may be aligned to overlap each other in a direction parallel to the central axis CX.

The jig pressing part 160 may further include an inner peripheral inclined surface 167 facing the outer peripheral inclined surface 150 of the slide jig 120 when the plurality of slide jigs 120 press the battery can 210. The inner peripheral inclined surface 167 may be spaced apart from the outer peripheral inclined surface 150 as illustrated in FIG. 11. However, in another embodiment of the present disclosure, the inner peripheral inclined surface may be in contact with the outer peripheral inclined surface.

The jig pressing part 160 may include an inner side surface 163 parallel to a movement direction of the jig pressing part 160 between the inner peripheral inclined surface 167 and the pusher 162. Each block part 130 of the plurality of slide jigs 120 is positioned between the outer peripheral inclined surface 150 and the plate part 122 and may include the outer side surface 145 parallel to the movement direction of the jig pressing part 160.

When the plurality of slide jigs 120 press the battery can 210, the outer side surface 145 of the slide jig 120 and the inner side surface 163 of the jig pressing part 160 may come into close contact with each other. For example, the outer side surface 145 and the inner side surface 163 may have a circular cross-sectional shape and may be a surface along the central axis CX.

The block part 130 may include at least one rotation preventing protrusion 147 protruding toward the inner side surface 163 on the outer side surface 145 and extending parallel to the movement direction of the jig pressing part 160. For example, the rotation preventing protrusion 147 may protrude in the radial direction and extend in a direction parallel to the central axis CX.

The jig pressing part 160 may include a rotation prevention groove 165 that is recessed inwardly so that the rotation preventing protrusion 147 is fitted thereinto and extends parallel to a longitudinal direction of the rotation preventing protrusion 147. The rotation preventing protrusion 147 and the rotation prevention groove 165 may correspond one-to-one.

Accordingly, since the plurality of slide jigs 120 may not rotate based on the central axis CX, precision of the crimping part 240 formation work and quality of the finally assembled secondary battery 200 can be improved. Meanwhile, unlike FIGS. 3 and 4, in the circumstance of at least another embodiment of the present disclosure, the jig pressing part may include the rotation preventing protrusion and the slide jig may include the rotation prevention groove corresponding to the rotation preventing protrusion.

As illustrated in FIGS. 2 and 11, when the block part 130 of the plurality of slide jigs 120 presses the battery can 210, the block part 130 may be positioned on an inner side of the jig pressing part 160 and the plate part 122 may be positioned on an outer side of the jig pressing part 160.

The apparatus for manufacturing a secondary battery 100 may further include an actuator (not shown) that provides power for moving the jig pressing part 160 in a direction toward the battery can 210 and in a direction away from the battery can 210. For example, based on FIGS. 10 and 11, a direction toward the battery can 210 may be a downward direction and the direction away from the battery can 210 may be an upward direction.

The plurality of slide jigs 120 may be elastically biased in the direction away from the battery can 210. The apparatus for manufacturing a secondary battery 100 may further include a spring (not shown) that elastically presses the plurality of slide jigs 120 in the direction away from the battery can 210. The direction in which the slide jig 120 is spaced apart from the battery can 210 may be a radial direction.

Accordingly, as illustrated in FIG. 11, when the block part 130 moves upwardly in a direction in which the jig pressing part 160 is spaced apart from the battery can 210 as illustrated in FIG. 10 from a state of being positioned on the inner side of the jig pressing part 160, the block part 130 of the plurality of slide jigs 120 may be spaced apart from the battery can 210 by an elastic force.

When the plurality of slide jigs 120 are spaced apart from the battery can 210 by an elastic force, the outer peripheral inclined surface 150 and the pusher 162 may not be aligned and not overlap each other in a direction parallel to the central axis CX. Therefore, the apparatus for manufacturing a secondary battery 100 may further include a stopper (not shown) blocking the slide jig 120 so that the slide jig 120 is not excessively spaced apart from the central axis CX.

A process of forming the crimping part 240 on the battery can 210 using the apparatus for manufacturing a secondary battery 100 of the present disclosure is as follows. First, the battery can 210 is inserted into a center of a through hole 105 of the frame part 102 by an automated robot or power of an operator while the jig pressing part 160 is spaced apart from the plurality of slide jigs 120 as illustrated in FIG. 10.

In this circumstance, the end corner 241 of the one side end portion 230 of the battery can 210 is not bent as illustrated as a two-dot chain line in FIG. 12, and the electrode assembly 300 (see FIG. 8) may be accommodated in the battery can 210, and the cap plate 260 and the gasket 280 may be placed on the beading part 220.

Next, when the jig pressing part 160 moves downward toward the battery can 210 along the central axis CX, the pusher 162 of the jig pressing part 160 presses the outer peripheral inclined surface 150 as illustrated in FIG. 11, and the plurality of slide jigs 120 move in the axial direction to surround the battery can 210.

Accordingly, the block part 130 of the plurality of slide jigs 120 presses the battery can 210, the round pressing surface 142 presses a portion including the end corner 241 of the one side end portion 230 to bend inwardly to form the crimping part 240.

Next, when the jig pressing part 160 moves upwardly to be spaced apart from the battery can 210 along the central axis CX, the plurality of slide jigs 120 move in the radial direction so that the block part 130 is spaced apart from the battery can 210 as illustrated in FIG. 10. The battery can 210 in which the crimping part 240 is formed is moved to a position away from the through hole 105 of the frame part 102 by an automated robot or power of an operator'.

According to the present disclosure, the open side end portion of the battery can be pressed toward the central axis of the battery can without being pressed in a longitudinal direction of the battery can so as to be bent toward the central axis of the battery can. Accordingly, damage to the end portion of the bent battery can is suppressed, and defects in secondary battery manufacturing work can be suppressed.

Since the apparatus for manufacturing a secondary battery according to the present disclosure has a simple structure, costs can be reduced and operational reliability can be improved.

However, aspects and features of the present disclosure are not limited to those described above and other aspects and features not mentioned will be clearly understood by those skilled in the art from the detailed description given above.

Although the present disclosure has been described with reference to some embodiments and drawings illustrating aspects thereof, the present disclosure is not limited thereto. Various modifications and variations can be made by a person skilled in the art to which the present disclosure belongs within the scope of the technical spirit of the disclosure and the claims and equivalents thereto.

What is claimed is:

1. An apparatus for manufacturing a secondary battery, comprising:
a jig part that moves from an outside of a battery can toward the battery can and presses the battery can to bend inwardly; and
a jig pressing part that presses the jig part so that the jig part presses the battery can by moving in a direction intersecting a movement direction of the jig part.

2. The apparatus as claimed in claim 1, wherein the jig part is movable in a direction toward the battery can and in a direction away from the battery can and includes a plurality of slide jigs for pressing the battery can.

3. The apparatus as claimed in claim 2, wherein the plurality of slide jigs are movable in a radial direction away from a central axis of the battery can and in a direction opposite to the radial direction.

4. The apparatus as claimed in claim 2, wherein at least one slide jig includes an end portion contact surface that moves toward the battery can and comes into contact with one side end portion of the battery can,
a round pressing surface that is connected to the end portion contact surface and presses the one side end portion so that the one side end portion is bent toward a central axis of the battery can, and
an inwardly protruding surface connected to the round pressing surface and protruding toward the central axis.

5. The apparatus as claimed in claim 4, wherein the battery can further includes a side wall spaced apart from the one side end portion, and
a beading part interposed between the one side end portion and the side wall and concavely recessed toward the central axis, and
the at least one slide jig further includes a side wall contact surface that comes into contact with the side wall, and
a beading part insertion protrusion positioned between the end portion contact surface and the side wall contact surface and protruding toward the central axis to be inserted into the beading part.

6. The apparatus as claimed in claim 5, wherein a shortest distance between the central axis and the beading part insertion protrusion is longer than a shortest distance between the central axis and the inwardly protruding surface.

7. The apparatus as claimed in claim 2, further comprising a frame part movably supporting at least one slide jig.

8. The apparatus as claimed in claim 7, wherein the frame part includes a hollow portion through which the battery can passes.

9. The apparatus as claimed in claim 7, wherein the frame part includes a slide groove into which the at least one slide jig is movably fitted.

10. The apparatus as claimed in claim 7, wherein any one of the frame part and the at least one slide jig includes a guide rail protruding toward the other and extending in a direction parallel to the movement direction of the slide jig, and
the other includes a long guide groove that is recessed inwardly so that the guide rail is fitted thereinto and extending parallel to a longitudinal direction of the guide rail.

11. The apparatus as claimed in claim 3, wherein the jig pressing part approaches the slide jig in a direction perpendicular to the movement direction of at least one slide jig and presses the at least one slide jig so that the at least one slide jig comes into close contact with the battery can.

12. The apparatus as claimed in claim 11, wherein the at least one slide jig includes an outer peripheral inclined surface opposite to the battery can and inclined with respect to the central axis CX, and
the jig pressing part includes a pusher for pressing the outer peripheral inclined surface to bring the at least one slide jig into contact with the battery can.

13. The apparatus as claimed in claim 12, wherein the jig pressing part further includes an inner peripheral inclined surface facing the outer peripheral inclined surface.

14. The apparatus as claimed in claim 13, wherein the jig pressing part includes an inner side surface parallel to the movement direction of the jig pressing part between the inner peripheral inclined surface and the pusher, and
the at least one slide jig includes an outer side surface in close contact with the inner side surface.

15. The apparatus as claimed in claim 11, wherein any one of the jig pressing part and the at least one slide jig includes a rotation preventing protrusion protruding toward the other and extending parallel to the movement direction of the jig pressing part, and
the other includes a rotation prevention groove which is recessed inwardly so that the rotation preventing protrusion is fitted thereinto and extending in a direction parallel to a longitudinal direction of the rotation preventing protrusion.

16. The apparatus as claimed in claim 11, wherein, when the plurality of slide jigs press the battery can, the plurality of slide jigs surround the battery can and are in close contact with one another.

17. The apparatus as claimed in claim 11, wherein the plurality of slide jigs are elastically biased in the direction away from the battery can.

18. The apparatus as claimed in claim 11, further comprising a frame part which movably supports the at least one slide jig and a hollow portion through which the battery can passes, and
the at least one slide jig includes:
a block part including an end portion contact surface which moves toward the battery can and comes into contact with one side end portion of the battery can, a round pressing surface which is connected to the end portion contact surface and presses the one side end portion so that the one side end portion is bent toward a central axis of the battery can, and an inwardly protruding surface which is connected to the round pressing surface and protrudes toward the central axis; and
a plate part which is connected to the block part and movably supported on the frame part.

19. The apparatus as claimed in claim 18, wherein the block part includes an outer peripheral inclined surface opposite to the battery can and inclined with respect to the central axis of the battery can, and
an outer side surface which is positioned between the outer peripheral inclined surface and the plate part and parallel to the movement direction of the jig pressing part, and
the jig pressing part includes a pusher for pressing the outer peripheral inclined surface to bring the block part into contact with the battery can,
an inner peripheral inclined surface facing the outer peripheral inclined surface, and
an inner side surface which is positioned between the outer peripheral inclined surface and in close contact with the outer side surface.

20. The apparatus as claimed in claim 18, wherein, when the block part presses the battery can, the block part is positioned on an inner side of the jig pressing part and the plate part is positioned on an outer side of the jig pressing part.
